(19) United States
(12) Patent Application Publication
(10) Pub. No.: US 2015/0128025 A1
(43) Pub. Date: May 7, 2015

(54) METHOD AND SYSTEM FOR CUSTOMIZING MULTIMEDIA CONTENT OF WEBPAGES

(71) Applicant: Cortica, Ltd., RAMAT GAN (IL)

(72) Inventors: Igal Raichelgauz, New York, NY (US); Karina Odinaev, New York, NY (US); Yehoshua Y. Zeevi, Haifa (IL)

(73) Assignee: Cortica, Ltd., RAMAT GAN (IL)

(21) Appl. No.: 14/597,324

(22) Filed: Jan. 15, 2015

Related U.S. Application Data
(63) Continuation-in-part of application No. 13/766,463, filed on Feb. 13, 2013.
Application No. 13/766,463 is a continuation-in-part of application No. 13/602,858, filed on Sep. 4, 2012, now Pat. No. 8,868,619.
Application No. 13/602,858 is a continuation of application No. 12/603,123, filed on Oct. 21, 2009, now Pat. No. 8,266,185.
Application No. 12/603,123 is a continuation-in-part of application No. 12/084,150, filed on Apr. 7, 2009, now Pat. No. 8,655,801.
Application No. 12/603,123 is a continuation-in-part of application No. 12/195,863, filed on Aug. 21, 2008, now Pat. No. 8,326,775.
Application No. 12/195,863 is a continuation-in-part of application No. 12/084,150, filed on Apr. 7, 2009, now Pat. No. 8,655,801.
Application No. 12/603,123 is a continuation-in-part of application No. 12/348,888, filed on Jan. 5, 2009.
Application No. 12/348,888 is a continuation-in-part of application No. 12/084,150, filed on Apr. 7, 2009, now Pat. No. 8,655,801.
Application No. 12/084,150 is a continuation-in-part of application No. 12/195,863, filed on Aug. 21, 2008, now Pat. No. 8,326,775.
Application No. 12/603,123 is a continuation-in-part of application No. 12/538,495, filed on Aug. 10, 2009, now Pat. No. 8,312,031.
Application No. 12/538,495 is a continuation-in-part of application No. 12/084,150, filed on Apr. 7, 2009, now Pat. No. 8,655,801.
Application No. 12/084,150 is a continuation-in-part of application No. 12/195,863, filed on Aug. 21, 2008, now Pat. No. 8,326,775.
Application No. 12/195,863 is a continuation-in-part of application No. 12/348,888, filed on Jan. 5, 2009.
(60) Provisional application No. 61/928,468, filed on Jan. 17, 2014.

(30) Foreign Application Priority Data
Oct. 26, 2005 (IL) 171577
Jan. 29, 2006 (IL) 173409
Aug. 21, 2007 (IL) 185414

(51) Int. Cl. G06F 17/22; G06F 17/30

(52) U.S. Cl. CPC G06F 17/2247; G06F 17/30592
USPC 715/234

(57) ABSTRACT

A method and system for customizing a webpage for display on a user device are provided. The system includes receiving a request to display the webpage on the user device; generating at least one signature for each multimedia content data element (MMDE) of a plurality of MMDEs associated with the webpage; determining, for each signature of the at least one signature, at least one concept structure; identifying at least one characteristic of a user of the user device; determining an alternate MMDE based on at least one of: the at least one characteristic, the at least one signature, and metadata associated with the at least one concept structure; and sending, to the user device, the webpage comprising the alternate MMDE.

### CROSS-REFERENCE TO RELATED APPLICATIONS

This application claims the benefit of U.S. Provisional Application No. 61/928,468, filed on Jan. 17, 2014. This application is a continuation-in-part of U.S. patent application Ser. No. 13/766,463 filed on Feb. 13, 2013, now allowed, which is a continuation-in-part of U.S. patent application Ser. No. 13/602,858 filed on Sep. 4, 2012, now U.S. Pat. No. 8,868,619, which is a continuation of U.S. patent application Ser. No. 12/603,123 filed on Oct. 21, 2009, now U.S. Pat. No. 8,266,185, which is a continuation-in-part of:
(1) U.S. patent application Ser. No. 12/084,150 having a filing date of Apr. 7, 2009, now U.S. Pat. No. 8,655,801, which is the National Stage of International Application No. PCT/IL2006/001235 filed on Oct. 26, 2006, which claims foreign priority from Israeli Application No. 171577 filed on Oct. 26, 2005, and Israeli Application No. 173409 filed on Jan. 29, 2006;
(2) U.S. patent application Ser. No. 12/195,863 filed on Aug. 21, 2008, now U.S. Pat. No. 8,326,775, which claims priority under 35 USC 119 from Israeli Application No. 185414, filed on Aug. 21, 2007, and which is also a continuation-in-part of the above-referenced U.S. patent application Ser. No. 12/084,150;
(3) U.S. patent application Ser. No. 12/348,888, filed on Jan. 5, 2009, now pending, which is a continuation-in-part of the above-referenced U.S. patent application Ser. No. 12/084,150, and the above-referenced U.S. patent application Ser. No. 12/195,863; and
(4) U.S. patent application Ser. No. 12/538,495, filed on Aug. 10, 2009, now U.S. Pat. No. 8,312,031, which is a continuation-in-part of the above-referenced U.S. patent application Ser. No. 12/084,150, the above-referenced U.S. patent application Ser. No. 12/195,863, and the above-referenced U.S. patent application Ser. No. 12/348,888.

All of the applications referenced above are herein incorporated by reference.

### TECHNICAL FIELD

The present invention relates generally to the analysis of multimedia content, and more specifically to a system for customizing multimedia content that exists in a webpage respective of information related to users.

### BACKGROUND

With the abundance of data made available through various means in general and, in particular, through the Internet and world-wide web (WWW), a need to understand likes and dislikes of users has become essential for online businesses.

Existing solutions for learning about the likes and dislikes of users provide several tools to identify users' preferences. Some of these solutions require active inputs from the users that specify their interests. As an example, one such solution may identify information a user has provided that explicitly lists several interests and utilize the identified information to generate a user profile reflecting these explicit interests. However, profiles generated for users based on their inputs may be inaccurate, as the users tend to provide only their current interests, or only partial information due to privacy concerns. For example, a user who is asked what his or her favorite movies are may respond by indicating movies that the user has seen relatively recently rather than the user's actual favorite movies.

Other existing solutions passively track the users' activity through particular web sites such as social networks. The disadvantage of such solutions is that, typically, limited information regarding the users is revealed, as users tend to provide only partial information due to privacy concerns. For example, users creating an account on Facebook® generally only provided the minimum mandatory information that is required for the creation of the account. Such minimum mandatory information may only indicate identifying information about the user (e.g., a name, an email address, a geographical location, and so on), and typically does not indicate the user's preferences (e.g., preferred types of content, preferred genres of content, favorite content, and so on).

The limitations of existing solutions make generating more precise user profiles significantly more difficult because such solutions frequently require the user to respond to one or more queries about the user's preferences to identify accurate preferences. These queries inconvenience the user, waste computing resources, and ultimately delay generation of the full user profile. Further, if the user fails to respond to these queries, the user profile remains incomplete and/or inaccurate.

Existing solutions are also typically incapable of actively utilizing the generated user profiles because such solutions generally simply store the generated user profiles for later use and/or send the user profiles to a content provider. Such solutions cannot, for example, create customized content for the user respective of his or her preferences. The ability to utilize generated user profiles would allow immediate provision of relevant content to users while removing the requirement for involvement by third party entities, thereby preserving computing resources and making provision of relevant resources faster and more accurate.

It would be therefore advantageous to provide a solution that overcomes the deficiencies of the prior art by efficiently identifying preferences of users and generating profiles thereof. It would be further advantageous if such a solution further allows customization of a webpage respective of the preferences.

### SUMMARY

A summary of several example aspects of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all aspects nor delineate the scope of any or all aspects. Its sole purpose is to present some concepts of one or more embodiments in a simplified form as a prelude to the more detailed description that is presented later. For convenience, the term some embodiments may be used herein to refer to a single embodiment or multiple embodiments of the disclosure.

Certain embodiments disclosed herein include a method and system for customizing a webpage for display on a user device. The system includes receiving a request to display the webpage on the user device; generating at least one signature for each multimedia content data element (MMDE) of a plurality of MMDEs associated with the webpage; determining, for each signature of the at least one signature, at least one concept structure; identifying at least one characteristic of a user of the user device; determining an alternate MMDE based on at least one of: the at least one characteristic, the at least one signature, and metadata associated with the at least one concept structure; and sending, to the user device, the webpage comprising the alternate MMDE.

### BRIEF DESCRIPTION OF THE DRAWINGS

The subject matter that disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a diagram of a deep-content-classification (DCC) system for creating concept structures in accordance with an embodiment.

FIG. 2 is a flowchart illustrating the operation of a patch attention processor (PAP) in accordance with an embodiment.

FIG. 3 is a block diagram depicting the basic flow of information in a large-scale video matching system.

FIG. 4 is a diagram showing the flow of patches generation, response vector generation, and signature generation in a large-scale speech-to-text system.

FIG. 5 is a flowchart illustrating the operation of the clustering processor (CP) in accordance with one embodiment.

FIG. 6 is a flowchart illustrating the operation of the concept generator in accordance with one embodiment.

FIG. 7 is a flowchart illustrating a method for generating a concept database in accordance with one embodiment.

FIG. 8 is a schematic diagram of a system for constantly adapting multimedia content that exists in a webpage in accordance with one embodiment.

FIG. 9 is a flowchart illustrating a method for customizing a webpage respective of users' characteristics in accordance with one embodiment.

### DETAILED DESCRIPTION

The embodiments disclosed herein are only examples of the many possible advantageous uses and implementations of the innovative teachings presented herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

A large-scale web-platform for a multimedia deep-content-classification (DCC) system is configured to analyze multimedia content elements that exist in a webpage. The DCC system initially receives a large number of multimedia data elements (MMDEs) to create a knowledge base that is condensed into concept structures that are efficient to store, retrieve, and check for matches. As new MMDEs are collected, they are efficiently added to the knowledge base and concept structures such that the computing resources requirement for achieving this operation is generally sub-linear rather than linear or exponential. Metadata respective of the MMDEs is thereby produced, forming together with the reduced clusters into a concept structure.

According to various embodiments disclosed herein, a request to display a webpage that contains a plurality of multimedia data elements (MMDEs) is received by the system. Each MMDE is mapped to the concept structures that exist in a concept database (DB).

According to one embodiment, the concept DB is comprised of two layers: (a) a concept structures database; and (b) a database of indices of original MMDEs mapped to the concept structures database. The architecture of the concept DB enables an external system to perform content management operations on the indices database because the volume of the indices is lower and, thus, the analysis requires fewer computational resources. All the necessary updates are performed by adding, removing, or updating the concept structures in the concept DB.

Upon receiving a request to display the webpage on a user device and receiving one or more characteristics related to the user of the user device, at least one concept structure is selected respective of the characteristics. Then, based on the selection of the concept structure one or more MMDEs are provided for display in the webpage on the display of the user device.

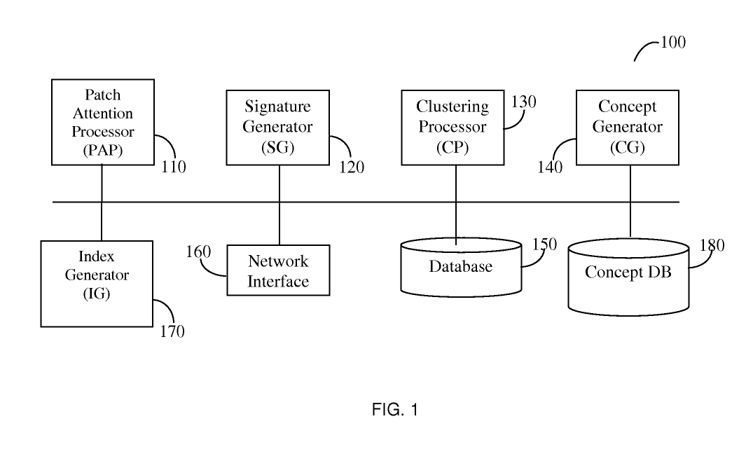

FIG. 1 shows an exemplary and non-limiting diagram of a DCC system 100 for creating concept structures according to an embodiment. The DCC system 100 includes a patch attention processor (PAP) 110, a signature generator (SG) 120, a clustering processor (CP) 130, a concept generator (CG) 140, a database (DB) 150, a network interface 160, an index generator (IG) 170, and a concept database (DB) 180. The DCC system 100 receives MMDEs from, for example, the Internet via the network interface 160. The MMDEs include, but are not limited to, images, graphics, video streams, video clips, audio streams, audio clips, video frames, photographs, images of signals, combinations thereof, and portions thereof. The images of signals are images featuring signals such as, but not limited to, medical signals, geophysical signals, subsonic signals, supersonic signals, electromagnetic signals, infrared signals, and combinations thereof.

The MMDEs may be stored in the database (DB) 150, and references to each MMDE are kept in the DB 150 for future retrieval of the respective MMDE. Such a reference may be, but is not limited to, a universal resource locator (URL).

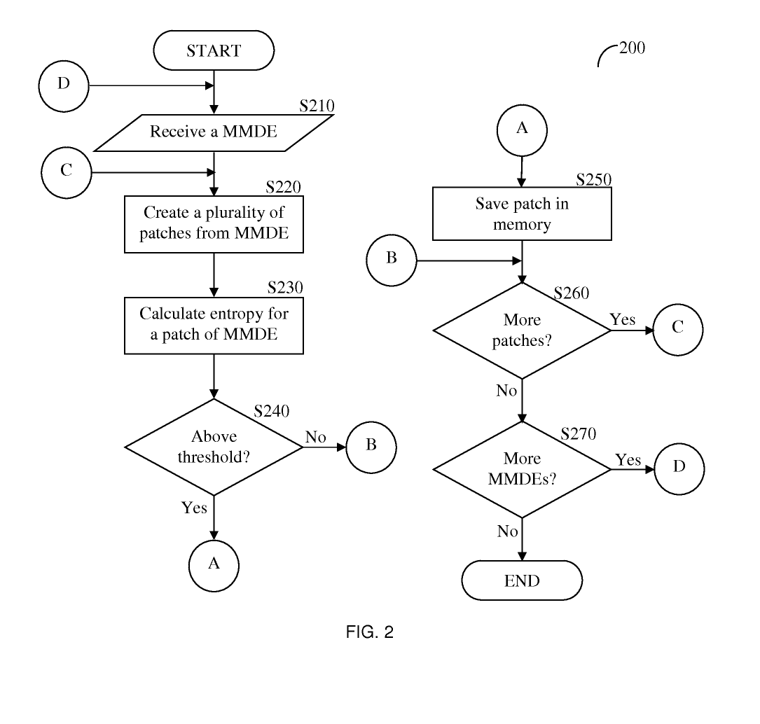

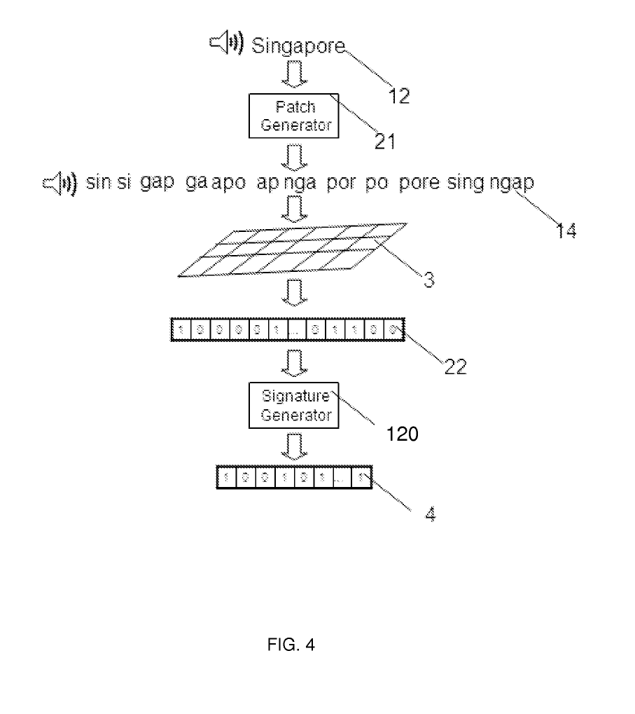

Every MMDE in the database 150, or reference thereof, is processed by a patch attention processor (PAP) 110, thereby resulting in a plurality of patches that are of specific interest, or otherwise of higher interest, than other patches. A more general pattern extractor, such as an attention processor (AP), can also be used in lieu of patches. The AP receives the MMDE that is partitioned into items. An item may be an extracted pattern or a patch, or any other applicable partition depending on the type of the MMDE. The functions of the patch attention processor 110 are described further herein below in more detail in FIG. 2. Those patches that are of higher interest are then used by a signature generator (SG) 120 to generate signatures respective of the patch. The operation of the SG 120 is described in more detail herein below with respect to FIG. 4.

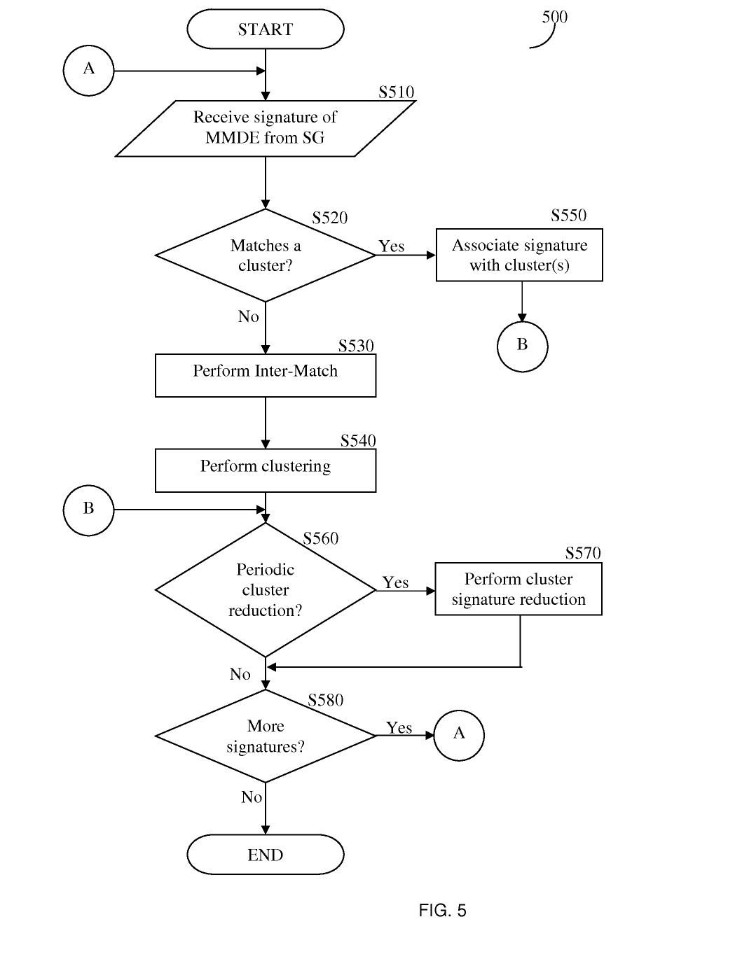

A clustering processor (CP) 130 initiates a process of inter-matching of the signatures upon determining that there are a number of patches above a predefined threshold. The threshold may be defined to be large enough to enable proper and meaningful clustering. The value of a threshold that is large enough to enable proper and meaningful clustering may be, for example, predetermined. With a plurality of clusters, a process of clustering reduction takes place so as to extract the most useful data about the cluster and keep it at an optimal size to produce meaningful results. The process of cluster reduction is continuous. When new signatures are provided after the initial phase of the operation of the clustering processor 130, the new signatures may be immediately checked against the reduced clusters to minimize the number of necessary inter-matches in future operations of the clustering processor 130. A more detailed description of the operation of the clustering processor 130 is provided herein below in FIG. 5.

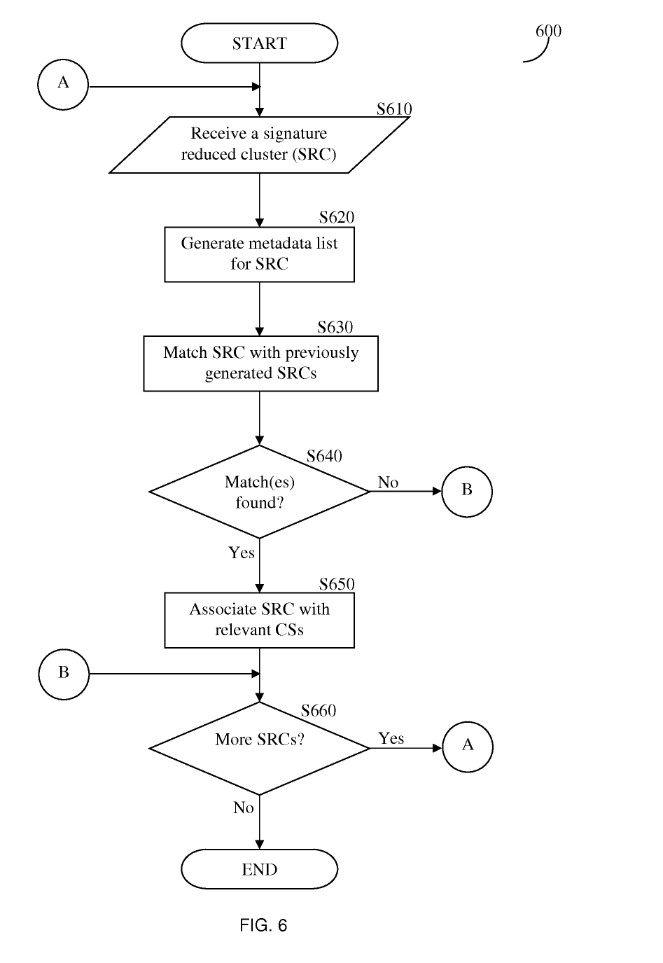

A concept generator (CG) 140 creates concept structures from the reduced clusters provided by the cluster processor 130. Each concept structure is comprised of a plurality of metadata associated with the reduced clusters. The result is a compact representation of a concept that can now be easily compared against a MMDE to determine if the received MMDE matches a concept structure stored, for example, in the database 150. This matching operation can be performed by the concept generator 140, for example, and without limitation, by providing a query to the DCC system 100 for finding a match between a concept structure and a MMDE. A more detailed description of the operation of the CG 140 is provided herein below in FIG. 6.

The index generator (IG) 170 is configured to extract metadata related to each of the plurality of MMDEs stored in the database 150 or referenced therefrom. The metadata may include patches created by the patch attention processor 110 for each MMDE. The metadata may also include one or more signatures generated by the signature generator 120 for each MMDE. The metadata may further include the concept structure identified for each of the MMDEs. Based on the metadata extracted, the index generator 170 is configured to generate a plurality of compressed conceptual representations, which will be referred to as indices, for each of the plurality of MMDEs stored in the database 150 or referenced therefrom.

In one embodiment, an index for a MMDE is generated by matching its respective metadata to a plurality of concept structures provided by the concept generator 140. Upon at least one matching concept structure being detected, an index to the matching structure is generated. For example, an image of a tulip would be mapped to a concept structure of “flowers.”

The plurality of indices is then stored in a concept database (DB) 180. The content management operations, such as, but not limited to, data retrieval, search, and so on, are performed using the indices saved in the concept database 180. In certain embodiments, the concept database 180 may be part of the database 150.

According to one embodiment, the concept database 180 includes two layers of data structures (or databases): one is for concept structures, and the other is for indices of the original MMDEs mapped to the concept structures in the concept database 180.

As noted above, a concept structure is a reduced cluster of MMDEs together with their respective metadata. Thus, the DCC system 100 can generate a number of concept structures that is significantly smaller than the number of MMDEs. Therefore, the number of indices required in the concept DB 180 is significantly smaller relative to a solution that requires indexing of raw MMDEs.

The operation of the patch attention processor 110 will now be provided in greater detail with respect to a MMDE in a form of an image. However, this should not be understood as to limit the scope of the disclosed embodiments, as other types of MMDEs are specifically included herein and may be handled by the patch attention processor 110.

FIG. 2 depicts an exemplary and non-limiting flowchart 200 of the operation of the patch attention processor 110 according to an embodiment. In S210, the patch attention processor 110 receives a MMDE from a source for such MMDEs. Such a source may be a system that feeds the DCC system 100 with MMDEs or other sources for MMDEs such as, for example, the world-wide-web (WWW). In S220, the patch attention processor 110 creates a plurality of patches from the MMDE. A patch of an image is defined by, for example, its size, scale, location, and orientation. A patch may be, for example and without limitation, a portion of an image of a size 20 pixels by 20 pixels, wherein the image is of a size 1,000 pixels by 500 pixels. In the case of audio, a patch may be a segment of audio 0.5 seconds in length from a 5 minute audio clip.

In S230, a patch not previously checked is processed to determine its entropy. The entropy is a measure of the amount of interesting information that may be present in the patch. For example, a continuous color of the patch has little interest, whereas sharp edges, corners, or borders will result in higher entropy representing a lot of interesting information. In one embodiment, a plurality of statistically independent cores, the operation of which is discussed in more detail herein below with respect to FIG. 4, is used to determine the level of interest of the image, and a process of voting takes place to determine whether the patch is of interest or not.

In S240, it is checked whether the entropy was determined to be above a predefined threshold, and if so execution continues with S250; otherwise, execution continues with S260. In S250 the patch having entropy above the predefined threshold is stored for future use by the SG 120 in, for example, the database 150. In S260, it is checked whether there are more patches of the MMDE to be checked, and if so execution continues with S220; otherwise execution continues with S270. In S270, it is checked whether there are additional MMDEs, and if so execution continues with S210; otherwise, execution terminates. It would be appreciated by those of skill in the art that this process reduces the information that must be handled by the DCC system 100 by focusing on areas of interest in the MMDEs rather than on areas that are less meaningful for the formation of a concept structure.

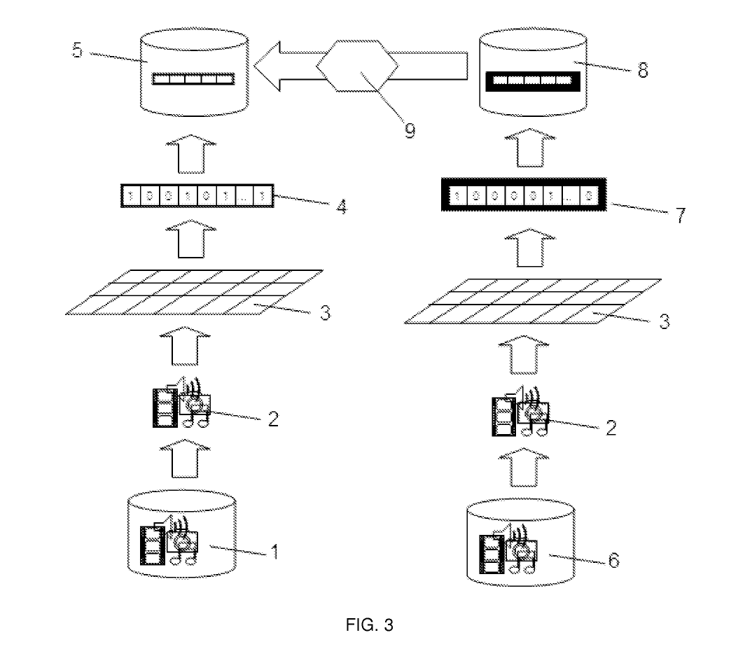

A high-level description of the process for large scale video matching performed by a Matching System is depicted in FIG. 3. Video content segments 2 from a Master DB 6 and a Target DB 1 are processed in parallel by a large number of independent computational Cores 3 that constitute the Architecture. Further details on the computational Cores generation are provided below. The independent Cores 3 generate a database of Robust Signatures and Signatures 4 for Target content-segments 5 and a database of Robust Signatures and Signatures 7 for Master content-segments 8. An exemplary and non-limiting process of signature generation for an audio component is shown in detail in FIG. 4. Referring back to FIG. 3, at the final step, Target Robust Signatures and/or Signatures are effectively matched, by a matching algorithm 9, to Master Robust Signatures and/or Signatures database to find all matches between the two databases.

A brief description of the operation of the signature generator 120 is therefore provided, this time with respect to a MMDE which is a sound clip. However, this should not be understood as to limit the scope of the disclosed embodiments and other types of MMDEs that are specifically included herein and may be handled by the signature generator 120. To demonstrate an example of signature generation process, it is assumed, merely for the sake of simplicity and without limitation on the generality of the invention, that the signatures are based on a single frame, leading to certain simplification of the computational core's generation. The Matching System shown in FIG. 3 is extensible for signatures generation capturing the dynamics in-between the frames and the information of the frame's patches.

The signatures generation process is now described with reference to FIG. 4. The first step in the process of signatures generation from a given speech-segment is to break-down the speech-segment into K patches 14 of random length P and random position within the speech segment 12. The break-down is performed by the patch generator component 21. The value of K is determined based on optimization, considering the tradeoff between accuracy rate and the number of fast matches required in the flow process of the System. In the next step, all the K patches are injected in parallel to all L computational Cores 3 to generate K response vectors 22. The vectors 22 are fed into the SG 120 to produce a Signatures and Robust Signatures 4.

In order to generate Robust Signatures, i.e., Signatures that are robust to additive noise L (where L is an integer equal to or greater than 1) computational cores are utilized in the Matching System. A frame i is injected into all the cores. The computational cores 3 generate two binary response vectors: \vec{S} which is a Signature vector, and \vec{RS} which is a Robust Signature vector.

For generation of signatures robust to additive noise, such as White-Gaussian-Noise, scratch, etc., but not robust to distortions, such as crop, shift and rotation, etc., a core Cᵢ={nᵢ} (1≦i≦L) may consist of a single leaky integrate-to-threshold unit (LTU) node or more nodes. The node ni equations are:

$${V}_{i} = {\sum }_{j} {w}_{ij} {k}_{j}$$

nᵢ=θ(V₁−THₓ); θ is a Heaviside step function; wᵢⱼ is a coupling node unit (CNU) between a node i and an image component j (for example, grayscale value of a certain pixel j); kⱼ is an image component j (for example, grayscale value of a certain pixel j); Thₓ is a constant Threshold value, where x is ‘S’ for Signature and ‘RS’ for Robust Signature; and Vᵢ is a Coupling Node Value.

The Threshold values Thₓ are set differently for Signature generation and for Robust Signature generation. For example, for a certain distribution of Vᵢ values (for the set of nodes), the thresholds for Signature (ThS) and Robust Signature (ThRS) are set apart, after optimization, according to at least one or more of the following criteria:
I: For: Vᵢ>Th_{RS}
   1−p(V>Th_{S})−1−(1-ε)^{l}<<1
      i.e., given that I nodes (cores) constitute a Robust Signature of a certain image I, the probability that not all of these I nodes will belong to the Signature of same, but noisy image, Ĩ is sufficiently low (according to a system's specified accuracy).
II: p(Vᵢ>Th_{RS})≈l/L
   i.e., approximately I out of the total L nodes can be found to generate Robust Signature according to the above definition.
III: Both Robust Signature and Signature are generated for a certain frame i.

It should be understood that the creation of a signature is a unidirectional compression where the characteristics of the compressed data are maintained but the compressed data cannot be reconstructed. Therefore, a signature can be used for the purpose of comparison to another signature without the need of comparison to the original data. The detailed description of the signature generation can be found U.S. Pat Nos. 8,326,775 and 8,312,031, assigned to common assignee, which are hereby incorporated by reference for all the useful information they contain.

Computational core generation is a process of definition, selection and tuning of the Architecture parameters for a certain realization in a specific system and application. The process is based on several design considerations, such as: (a) The cores should be designed so as to obtain maximal independence, i.e., the projection from a signal space should generate a maximal pair-wise distance between any two cores' projections into a high-dimensional space; (b) The cores should be optimally designed for the type of signals they process, i.e. the cores should be maximally sensitive to the spatio-temporal structure of the injected signal, for example, and in particular, sensitive to local correlations in time and space. Thus, in some cases a core represents a dynamic system, such as in state space, phase space, edge of chaos, etc., which is uniquely used herein to exploit their maximal computational power, and, (c) The cores should be optimally designed with regard to invariance to a set of signal distortions, of interest in relevant application.

A detailed description of the computational core generation and the process for configuring such cores is discussed in more detail in the above-referenced U.S. patent application Ser. No. 12/084,150, now U.S. Pat. No. 8,655,801, assigned to the common assignee, and is hereby incorporated by reference for all that it contains.

According to certain embodiments, signatures are generated by the signature generator 120 responsive of patches either received from the patch attention processor 110, or retrieved from the database 150. It should be noted that other ways for generating signatures may also be used for the purpose the DCC system 100. Furthermore, as noted above, the array of cores may be used by the patch attention processor 110 for the purpose of determining if a patch has an entropy level that is of interest for signature generation according to the principles of the disclosed embodiments. The generated signatures are stored, for example, in the database 150, with reference to the MMDE and the patch for which it was generated, thereby enabling backward annotation as may be necessary.

Portions of the clustering processor 130 have been discussed in detail in U.S. patent application Ser. No. 12/507,489 (the “489 Application”), now U.S. Pat. No. 8,386,400, entitled “Unsupervised Clustering of Multimedia Data Using a Large-Scale Matching System”, filed Jul. 22, 2009, assigned to common assignee, and which is hereby incorporated for all that it contains. In accordance with an embodiment, an inter-match process and clustering thereof is utilized. The process can be performed on signatures provided by the signature generator 120. It should be noted that this inter-matching and clustering process is merely an example for the operation of the clustering processor 130 and other inter-matching and/or clustering processes can also be utilized.

Following is a description of the inter-match and clustering process. The unsupervised clustering process maps a certain content-universe onto a hierarchical structure of clusters. The content-elements of the content-universe are mapped to signatures, when applicable. The signatures of all the content-elements are matched to each other, and consequently generate the inter-match matrix. The described clustering process leads to a set of clusters. Each cluster is represented by a small/compressed number of signatures, for example, signatures generated by the signature generator 120 as further explained hereinabove, which can be increased by variants. This results in a highly compressed representation of the content-universe. In an embodiment, a connection graph between the MMDEs of a cluster may be stored. The graph can then be used to assist a user searching for data to move along the graph in the search of a desired MMDE.

Upon determination of a cluster, a signature for the whole cluster may be generated based on the signatures of the MMDEs that belong to the cluster. It should be appreciated that using a Bloom filter may be used to reach such signatures. Furthermore, as the signatures generated by the signature generator 120 are correlated to some extent, the hash functions of the Bloom filter may be replaced by simpler pattern detectors, with the Bloom filter being the upper limit.

While signatures are used herein as the basic data elements, it should be realized that other data elements may be clustered using the DCC system 100. For example, when a system generating data items is used, the data items generated may be clustered according to the disclosed embodiments. Such data items may be, without limitation, MMDEs. The clustering process may be performed by dedicated hardware or by using a computing device having storage to store the data items generated by the system and configured to perform the process described herein above. Then, the clusters can be stored in memory for use as may be deemed necessary.

The clustering processor 130 further uses an engine designed to reduce the number of signatures used in a structure. This reduction can be performed by extracting only the most meaningful signatures that identify the cluster uniquely. This extraction can be done by testing a removal of a signature from a cluster and checking if the MMDEs associated with the cluster are still capable of being recognized by the cluster through signature matching. The process of signature extraction is continually performed throughout operation of the DCC system 100. It should be noted that, after initialization, upon signature generation by the signature generator 120 of a MMDE, its respective signature is first checked against the clusters to see if there is a match, and if so it may not be necessary to add the signature to the cluster or clusters, but rather simply associate the MMDE with the identified cluster or clusters. However, in some cases where additional refinement of the concept structure is possible, the signature may be added, or at times even replace one or more of the existing signatures in the reduced cluster. If no match is found, the process of inter-matching and clustering may take place.

FIG. 5 depicts an exemplary and non-limiting flowchart 500 of the operation of the clustering processor 130 according to an embodiment. In S510, a signature of a MMDE is received, for example from the signature generator 120. In S520, it is checked whether the received signature matches one or more existing clusters and, if so, execution continues with S550; otherwise, execution continues with S530. In S530, an inter-match between a plurality of signatures previously received by the DCC system 100 is performed, for example in accordance with the principles of the '489 Application. As may be necessary, the database 150 may be used to store results or intermediate results as the case may be, however, other memory elements may also be used. In S540, clustering is performed, for example, as discussed in the '489 Application. As may be necessary, the database 150 may be used to store results or intermediate results as the case may be, however, other memory elements may be used for this purpose as well.

In S550, the signature identified to match one or more clusters is associated with the existing cluster(s). In S560, it is checked whether a periodic cluster reduction is to be performed, and if so execution continues with S570; otherwise, execution continues with S580. In S570, cluster reduction is performed. Specifically, to the cluster reduction ensures that in the cluster remains the minimal number of signatures that still identify all of the MMDEs that are associated with the signature reduced cluster (SRC). This can be performed, for example, by attempting to match the signatures of each of the MMDEs associated with the SRC having one or more signatures removed therefrom. If all of the signatures of MMDEs still match the cluster, then appropriate cluster reduction was performed. The process of cluster reduction for the purpose of generating SRCs is performed in parallel and independent of the process described herein above. In such a case, after either S560 or S570, the operation of S580 takes place.

In S580, it is checked whether there are additional signatures to be processed and, if so, execution continues with S510; otherwise, execution terminates. SRCs may be stored in memory, such as the database 150, for the purpose of being used by other elements of the DCC system 100.

The concept generator 140 performs two tasks: it associates metadata with the SRCs provided by the clustering processor 130, and it associates between similar clusters based on commonality of metadata. Exemplary and non-limiting methods for associating metadata with MMDEs is described in U.S. patent application Ser. No. 12/348,888 (the “'888 Application’”(, entitled “Methods for Identifying Relevant Metadata for Multimedia Data of a Large-Scale Matching System”, filed on Jan. 5, 2009, assigned to common assignee, and which is hereby incorporated for all that it contains. One embodiment of the '888 Application includes a method for identifying and associating metadata to input MMDEs. The method comprises comparing an input first MMDE to at least a second MMDE; collecting metadata of at least the second MMDE when a match is found between the first MMDE and at least the second MMDE; associating at least a subset of the collected metadata to the first MMDE; and storing the first MMDE and the associated metadata in a storage.

Another embodiment of the '888 Application includes a system for collecting metadata for a first MMDE. The system comprises a plurality of computational cores enabled to receive the first MMDE, each core having properties statistically independent of each other core, each core generates responsive to the first MMDE a first signature element and a second signature element, the first signature element being a robust signature; a storage unit for storing at least a second MMDE, metadata associated with the second MMDE, and at least one of a first signature and a second signature associated with the second MMDE, the first signature being a robust signature; and a comparison unit for comparing signatures of MMDEs coupled to the plurality of computational cores and further coupled to the storage unit for the purpose of determining matches between multimedia data elements; wherein responsive to receiving the first MMDE the plurality of computational cores generate a respective first signature of said first MMDE and/or a second signature of said first MMDE, for the purpose of determining a match with at least a second MMDE stored in the storage and associating metadata associated with at least the second MMDE with the first MMDE.

Similar processes to match metadata with a MMDE or signatures thereof can also be utilized, however, these should be viewed only as exemplary and non-limiting implementations, and other methods of operation may be used with respect to the DCC system 100 without departing from the scope of the disclosed embodiments. Accordingly, each SRC is associated with metadata which is the combination of the metadata associated with each of the signatures that are included in the respective SRC, preferably without repetition of metadata. A plurality of SRCs having metadata may then be associated to each other based on the metadata and/or partial match of signatures. For example, and without limitation, if the metadata of a first SRC and the metadata of a second SRC overlap more than a predetermined threshold level (for example, by 50% of the metadata match) they may be considered associated clusters that form a concept structure. Similarly, a second threshold level can be used to determine if there is an association between two SRCs where at least a number of signatures above the second threshold are identified as a match with another SRC. As a non-limiting example, consider the concept of Abraham Lincoln where images of the late President and features thereof appear in a large variety of photographs, drawings, paintings, sculptures, and more, and are associated as a concept structure of the concept “Abraham Lincoln”. Each concept structure may then be stored in memory, for example, the database 150, for further use.

FIG. 6 shows an exemplary and non-limiting flowchart 600 of the operation of the concept generator 140 according to an embodiment. In S610, a SRC is received. In an embodiment, the SRC may be received either from the clustering processor 130 or by accessing, for example, the database 150. In S620, metadata are generated for the signatures of the SRC. The process for generating metadata for the SRC is described in further detail herein above. A list of the metadata is created for the SRC preferably with no metadata duplication. In one embodiment, the commonality of metadata is used to signify the strength of the metadata with respect to a signature and/or to the SRC, i.e., a higher number of metadata repetitions is of more importance to the SRC than a lower number of repetitions. Furthermore, in one embodiment, a threshold may be used to remove those metadata that have a significantly low rate of repetition as not being representative of the SRC.

In S630, the SRC is matched to previously generated SRCs to attempt to find various matches, as described, for example, hereinabove in more detail. In S640, it is checked if at least one match was found and, if so, execution continues with S650; otherwise, execution continues with S660. In S650, the SRC is associated with one or more of the concept structures to which the SRC has been shown to match. In S660, it is checked whether additional SRCs have been received, and if so execution continues with S610; otherwise, execution terminates.

A person skilled in the art should appreciate that the DCC system 100 creates automatically, and in an unsupervised fashion, concept structures of a wide variety of MMDEs. When checking a new MMDE, it may be checked against the concept structures stored, for example, in the database 150 and/or the concept database 180, and upon detection of a match provides the concept information about the MMDE. With the number of concept structures being significantly lower than the number of MMDEs, the solution is cost effective and scalable for the purpose of identification of content of a MMDE.

According to various embodiments disclosed herein, the concept structures are further utilized to index the MMDEs, in particular, to a set of indices that are created based on mapping to the concept structures database. The indices of the MMDEs are stored in the database 180, whereas the MMDEs can be deleted.

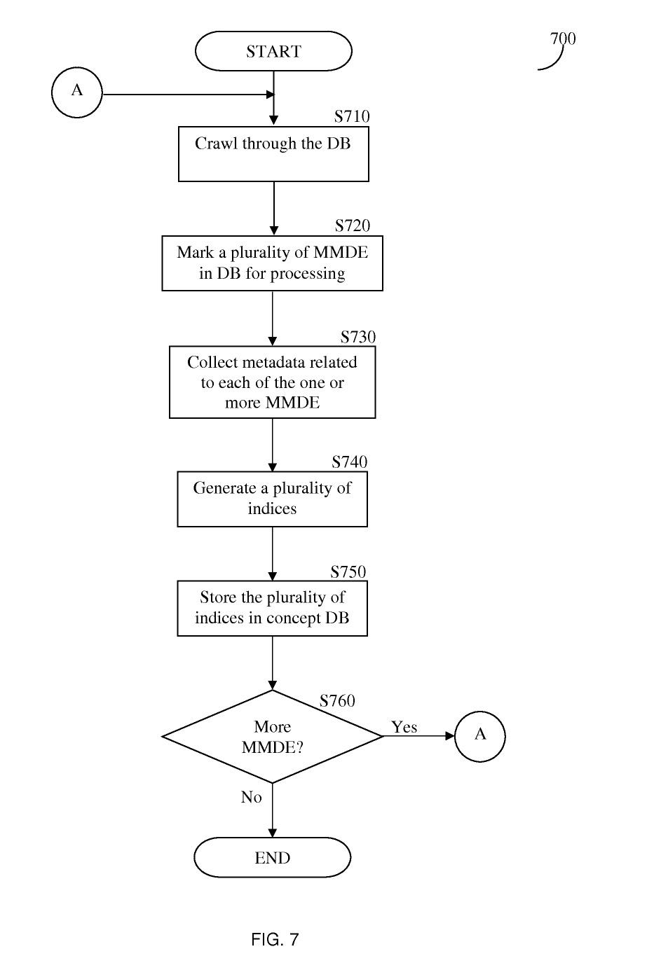

FIG. 7 shows an exemplary and non-limiting flowchart 700 of the operation of the index generator 170 in accordance with one embodiment disclosed herein. In S710, the index generator 170 crawls through the database 150 to access and identify MMDEs stored therein or referenced therefrom. In S720, each of the identified MMDEs is marked as required for further processing. In S730, metadata respective of each of the identified MMDEs is collected. As noted above, the metadata may be in the form of the plurality of patches created by the patch attention processor 110 from each MMDE, one or more signatures generated by the signature generator 120 respective of each MMDE, and the concept structure matched for each MMDE respective of the signatures of the MMDE. The metadata may be collected from such resources respectively.

In S740, using the collected metadata, the index generator 170 generates a plurality of indices respective of each MMDE. In one embodiment, S740 includes matching the metadata of a MMDE against concept structures saved in the concept database 180. For each matching concept structure, an index is generated for the MMDE. The index is a mapping of a MMDE to a matching concept structure.

In S750, the plurality of indices is stored in the concept database 180 for future use. As noted above, in an embodiment, the concept database 180 maintains the concept structures. In another embodiment, the concept structures are saved in the database 150, which may also include the concept database 180. The concept structures are generated by the concept generator 140 as discussed above. It should be noted that if the metadata of the respective MMDE does not match any of concept structures, a request is sent for the concept generator 140 to create a new structure; alternatively an error message may be generated and displayed on the display of a user device.

In S760, it is checked by the index generator 170 whether there are additional MMDEs in the database 150, and if so, execution continues with S710; otherwise, execution terminates.

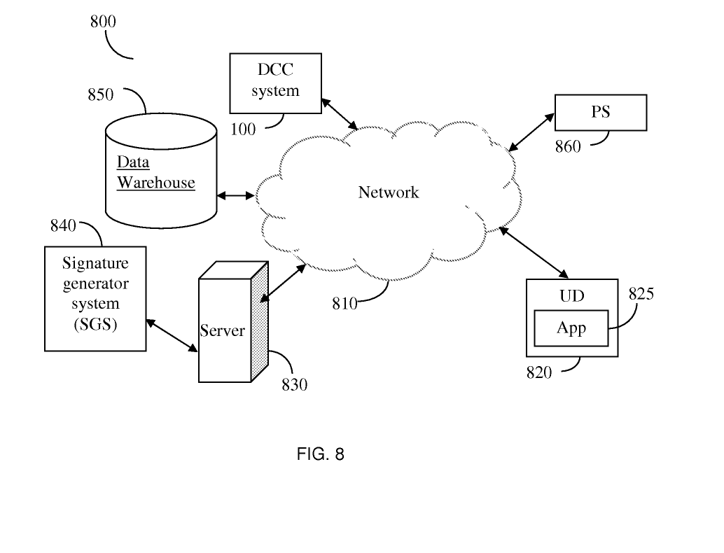

FIG. 8 shows an exemplary and non-limiting schematic diagram of a network system 800 utilized to describe the various embodiments disclosed herein. A network 810 is used to communicate between different components of the network system 800. The network 810 may be the Internet, the world-wide-web (WWW), a local area network (LAN), a wide area network (WAN), a metro area network (MAN), and other networks capable of enabling wired or wireless communication between the components of the network system 800.

Further connected to the network 810 is a user device 820. A user device 820 may be, for example, a personal computer (PC), a personal digital assistant (PDA), a mobile phone, a smart phone, a tablet computer, an electronic wearable device (e.g., glasses, a watch, etc.), and other kinds of wired and mobile appliances, equipped with browsing, viewing, capturing, storing, listening, filtering, and managing capabilities.

The user device 820 may further include a software application (App) 825 installed thereon. The software application 825 may be downloaded from an application repository, such as the AppStore®, Google Play®, or any repositories hosting software applications. The software application 825 may be pre-installed in the user device 820. The software application 825 contains a plurality of instructions that are to be executed on a processor, for example, a processing element (not shown) of the user device 820. In one embodiment, the software application 825 is a web browser. It should be noted that only one user device 820 and one software application 825 are discussed with reference to FIG. 8 merely for the sake of simplicity. However, the embodiments disclosed herein are applicable to a plurality of user devices that can access a server and multiple software applications installed thereon.

Also communicatively connected to the network 810 is a data warehouse 850. The data warehouse 850 stores therein both the concept structures and indices of MMDEs mapped to the concept structures-database as further discussed hereinabove. In the embodiment illustrated in FIG. 8, a server 830 communicates with the data warehouse 850 through the network 810. In other non-limiting configurations, the server 830 is directly connected to the data warehouse 850.

The network system 800 shown in FIG. 8 includes a signature generator system (SGS) 840 and a deep-content classification (DCC) system 100 which are utilized by the server 830 to perform the various disclosed embodiments. The signature generator system 840 and the DCC system 100 may be connected to the server 830 directly or through the network 810. In certain configurations, the DCC system 100 and the signature generator system 840 may be embedded in the server 830. It should be noted that the server 830 typically comprises a processor and a memory (not shown). The processor is coupled to the memory, which is configured to contain instructions that can be executed by the processing unit. The server 830 also includes a network interface (not shown) to the network 810. In one embodiment, the server 830 is commutatively connected or includes an array of computational cores configured as further discussed herein above.

The server 830 is configured to receive MMDEs from a publisher server (PS) 860 through the network 810. The publisher server 860 operates one or more webpages and includes the MMDEs shown in the webpages stored therein. A MMDE may be, for example, an image, a graphic, a video stream, a video clip, an audio stream, an audio clip, a video frame, a photograph, and an image of signals (e.g., spectrograms, phasograms, scalograms, etc.), and/or combinations thereof and portions thereof.

The server 830 is further configured to collect characteristics related to the user of the user device 820 from the user device 820 or from the software application 825 installed therein through the network 810. The characteristics may include, for example, the location of the user device 820, previously viewed content, the user's profile, demographic information related to the user, and so on.

In an embodiment, the server 830 receives a request to display a webpage on the user device 820, the webpage containing a plurality of multimedia data elements (MMDEs). The server 830 sends a request to the signature generator system 840 to generate at least one signature for each MMDE. The MMDEs displayed in the webpage are analyzed and at least one signature is generated respective of each MMDE. The generation of the signatures is further described hereinabove with respect to FIGS. 3 and 4. The generated signature(s) may be robust to noise and distortion.

Respective of the generated signature(s), at least one concept structure having an associated MMDE and metadata that exists in the database 850 is selected. The server 830 is further configured to identify one or more characteristics related to the user of the user device 820. Respective of the one or more characteristics and the one or more associated concept structures, at least one alternate MMDE stored in the database 850 is selected for display in the webpage on the user device 820. The selection may be performed to, e.g., display an alternate MMDE that is more relevant to the user than another MMDE. Relevance of an MMDE to the user may be determined based on, but is not limited to, a comparison of the MMDE to one or more of the user's characteristics. This comparison may be performed by, e.g., performing signature matching between a signature of the MMDE and a signature of the concept structure. As an example, if certain content is associated with a certain concept structure only capable of being viewed by users located in Madison Square Garden in New York, than that location is associated with this certain concept structure. The alternate MMDE of Madison Square Garden may replace or be added to the MMDEs currently displayed in the webpage.

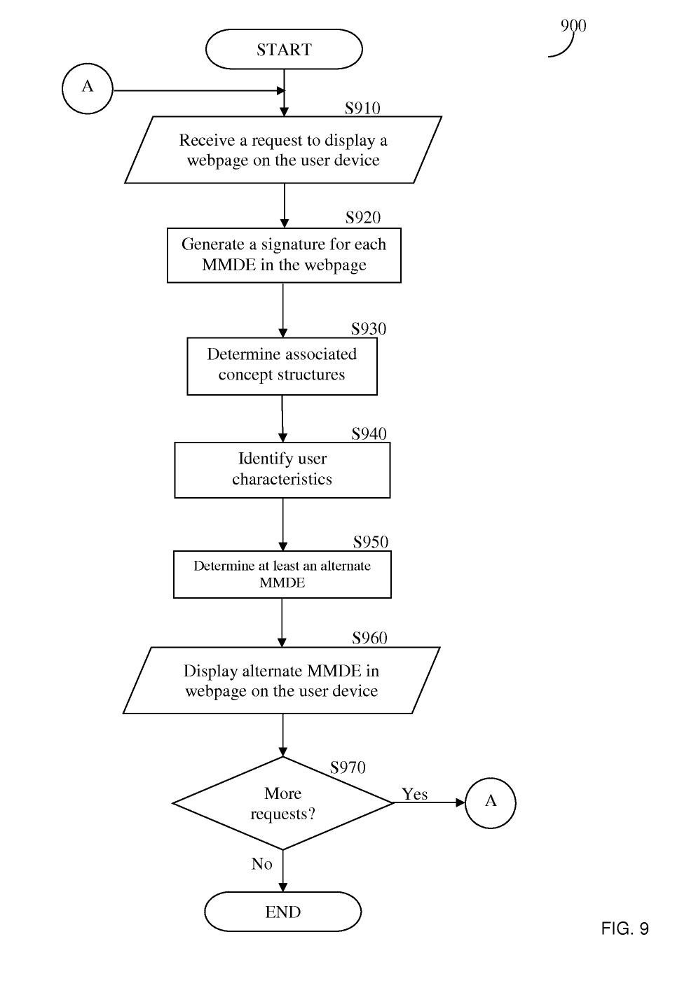

FIG. 9 shows an exemplary and non-limiting flowchart 900 of a method for customizing multimedia content that exists in a webpage in accordance with one embodiment. In an embodiment, the steps of flowchart 900 may be performed by a server (e.g., the server 830). In a further embodiment, the server may be communicatively connected to a signature generator system (e.g., the signature generator system 840) which generates signatures respective of one or more MMDEs. At S910, a request to display a webpage containing a plurality of MMDEs is received from a user device such as, for example, the user device 820.

In S920, a request to generate a signature for each MMDE is sent. The generation of signatures is further described hereinabove with respect of FIGS. 3 and 4. In S930, at least one concept structure of signatures having associated MMDEs and metadata that exists in the database 850 is determined.

In S940, one or more characteristics related to the user of a user device (e.g., the user device 820) are identified. In S950, at least one alternate MMDE stored in a database (e.g., the database 850) is selected responsive of the one or more characteristics, the signatures, and the metadata. The selection may be performed to, e.g., display an alternate MMDE that is more relevant to the user than another MMDE. Relevance of an MMDE to the user may be determined based on, but is not limited to, a comparison of the MMDE to one or more of the user's characteristics. This comparison may be performed by, e.g., performing signature matching between a signature of the MMDE and a signature of the concept structure. The alternate MMDE is an MMDE to be displayed in the webpage on the user device. In some embodiments, various alternate MMDEs may be considered, and the most relevant among those alternate MMDEs will be selected to be displayed.

In an embodiment, the alternate MMDE may replace an MMDE of the plurality of MMDEs contained in the webpage. In a further embodiment, the alternate MMDE may be the same type and/or may occupy the same size of a display as the replaced MMDE. As a non-limiting example, a video occupying a display size of 500 pixels by 500 pixels that is among the plurality of MMDEs may be replaced by an alternate MMDE that is a video occupying a display size of 500 pixels by 500 pixels. As another non-limiting example, a video occupying a display size of 500 pixels by 500 pixels that is among the plurality of MMDEs may be replaced by an alternate MMDE that is a video occupying a display size of 100 pixels by 100 pixels. As yet another non-limiting example, a video occupying a display size of 500 pixels by 500 pixels that is among the plurality of MMDEs may be replaced by an alternate MMDE that is a static image occupying a display size of 100 pixels by 100 pixels.

In S960, the alternate MMDE is sent for display in the webpage on the user device. The alternate MMDE may either replace an MMDE of the plurality of MMDEs, or may be displayed in addition thereto. In S970, it is checked whether there are additional requests and, if so, execution continues with S910; otherwise, execution terminates.

As a non-limiting example, a request to display a sports webpage is received from a user device. Metadata collected related to the user of the user device indicates that the user frequently views basketball-related content. Based on the metadata, basketball pictures and videos are selected and sent for display on the display on the user device as alternate MMDEs. Such alternate MMDEs may replace sports content on the webpage that does not relate to basketball (e.g., an article about the PGA tour for golf).

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What we claim is:

1. A method for customizing a webpage for display on a user device, comprising:
receiving a request to display the webpage on the user device;
generating at least one signature for each multimedia content data element (MMDE) of a plurality of MMDEs associated with the webpage;
determining, for each signature of the at least one signature, at least one concept structure;
identifying at least one characteristic of a user of the user device;
determining an alternate MMDE based on at least one of: the at least one characteristic, the at least one signature, and metadata associated with the at least one concept structure; and
sending, to the user device, the webpage comprising the alternate MMDE.

2. The method of claim 1, wherein the alternate MMDE replaces the at least one MMDE of the plurality of MMDEs.

3. The method of claim 1, wherein the plurality of MMDEs is at least one of: an image, a graphic, a video signal, an audio signal, a photograph, an image of signals, and a portion thereof.

4. The method of claim 1, wherein the at least one characteristic of the user is at least one of: a location of the user device, previously viewed content, a user profile, and demographic information related to the user.

5. The method of claim 1, further comprising:
storing the plurality of MMDEs in a data warehouse.

6. The method of claim 5, further comprising:
collecting metadata for the stored plurality of MMDEs;
generating a plurality of indices respective of each of the stored plurality of MMDEs; and
storing the plurality of indices in the data warehouse.

7. The method of claim 5, wherein the alternate MMDE is retrieved from the data warehouse.

8. A non-transitory computer readable medium having stored thereon instructions for causing one or more processing units to execute the method according to claim 1.

9. A system for customizing a webpage for display on a user device comprising:
a network interface for allowing connectivity to at least the user device;
a processor; and
a memory connected to the processor, the memory contains instructions that when executed by the processor, configure the system to:
receive a request to display the webpage on the user device;
generate at least one signature for each multimedia content data element (MMDE) of a plurality of MMDEs associated with the webpage;
determine, for each signature of the at least one signature, at least one concept structure;
identify at least one characteristic of a user of the user device;
determine an alternate MMDE based on at least one of: the at least one characteristic, the at least one signature, and metadata associated with the at least one concept structure; and
send, to the user device, the webpage comprising the alternate MMDE.

10. The system of claim 9, wherein the alternate MMDE replaces the at least one MMDE of the plurality of MMDEs.

11. The system of claim 9, wherein the plurality of MMDEs is at least one of: an image, a graphic, a video signal, an audio signal, a photograph, an image of signals, and a portion thereof.

12. The system of claim 9, wherein the at least one characteristic of the user is at least one of: a location of the user device, previously viewed content, a user profile, and demographic information related to the user.

13. The system of claim 9, the system is further configured to:
store the plurality of MMDEs in a data warehouse.

14. The system of claim 13, the system is further configured to:
collect metadata for the stored plurality of MMDEs;
generate a plurality of indices respective of each of the stored plurality of MMDEs; and
store the plurality of indices in the data warehouse.

15. The system of claim 13, wherein the alternate MMDE is retrieved from the data warehouse.
